(19) United States
(12) Patent Application Publication
(10) Pub. No.: US 2026/0138243 A1
(43) Pub. Date: May 21, 2026

(54) IMPACT ROTARY TOOL

(71) Applicant: Panasonic Intellectual Property Management Co., Ltd., Osaka (JP)

(72) Inventors: Ryosuke ISHIDA, Osaka (JP); Akito NAKAMURA, Mie (JP)

(21) Appl. No.: 19/379,825

(22) Filed: Nov. 5, 2025

(30) Foreign Application Priority Data
Nov. 21, 2024 (JP) 2024-203520
May 29, 2025 (JP) 2025-090053

(51) Int. Cl. B25B 21/02; B25F 5/00; B25B 23/00

(52) U.S. Cl. CPC B25B 21/026; B25F 5/001; B25B 23/0035

(57) ABSTRACT

An impact rotary tool according to the present disclosure includes a motor, an output shaft, a hit portion, a speed reducing mechanism, and an impact mechanism. The motor causes a rotary shaft to rotate. A tip tool is attachable to the output shaft. The hit portion rotates together with the output shaft. The speed reducing mechanism decelerates rotation of the rotary shaft and transmits rotation that has been decelerated to the output shaft. The impact mechanism includes a hammer member. The hammer member rotates in response to rotation of the rotary shaft and hits the hit portion. The impact mechanism is disposed between the speed reducing mechanism and the motor.

### CROSS-REFERENCE TO RELATED APPLICATIONS

The present application is based upon, and claims the benefit of priority to, Japanese Patent Application No. 2025-090053, filed on May 29, 2025, and Japanese Patent Application No. 2024-203520, filed on November 21, 2024, the entire contents of which are hereby incorporated by reference.

### TECHNICAL FIELD

The present disclosure generally relates to an impact rotary tool, and more particularly relates to an impact rotary tool configured to cause an output shaft to rotate by applying impacting force.

### BACKGROUND ART

Literature 1 (JP 2010-280021 A) discloses an impact wrench. The impact wrench in the literature 1 includes a column-shaped spindle to be caused to rotate by a motor, an anvil, a main hammer, a sub-hammer, and a rotary impact mechanism.

The anvil is disposed forward in a direction of a rotation axis of the spindle. The anvil includes, in a front portion thereof, a hole into which a screwdriver bit is inserted, and is provided with, in the rear portion thereof, a first claw. The main hammer is fitted to an outer periphery of the spindle and provided, in the front portion thereof, with a second claw that engages with the first claw. The main hammer can rotate about the rotation axis of the spindle and move in the direction of the rotation axis of the spindle. The sub-hammer includes a circular cylindrical portion that rotates together with the main hammer. In the interior space of the circular cylindrical portion, the spindle is inserted and the main hammer is housed.

The rotary impact mechanism is interposed between the spindle and the main hammer. When torque having a torque value greater than a predetermined value is applied between the spindle and the main hammer, the rotary impact mechanism causes the main hammer to rotate and to advance toward the anvil and causes the second claw to engage impulsively with the first claw to hit the first claw, thereby causing the anvil to rotate about the rotation axis.

### SUMMARY

An object of the present disclosure is to provide an impact rotary tool which may reduce the hitting sound.

An impact rotary tool according to an aspect of the present disclosure includes a motor, an output shaft, a hit portion, a speed reducing mechanism, and an impact mechanism. The motor is configured to cause a rotary shaft to rotate. A tip tool is attachable to the output shaft. The hit portion is configured to rotate together with the output shaft. The speed reducing mechanism is configured to decelerate rotation of the rotary shaft and transmits rotation that has been decelerated to the output shaft. The impact mechanism includes a hammer member that rotates in response to the rotation of the rotary shaft and hits the hit portion. The impact mechanism is disposed between the speed reducing mechanism and the motor.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is an exploded perspective view illustrating a main part of an impact rotary tool according to the present disclosure;

FIG. 2 is a side view illustrating the impact rotary tool;

FIG. 3 is an exploded perspective view illustrating the impact rotary tool;

FIG. 4 is an exploded perspective view illustrating a main part of the impact rotary tool;

FIG. 5 is a cross-sectional view of a main part of the impact rotary tool;

FIG. 6 is a cross-sectional view taken along the plane A1-A2 of FIG. 2;

FIG. 7 is an exploded perspective view illustrating a main part of an impact rotary tool according to a first variation of the exemplary embodiment in the present disclosure;

FIG. 8 is a perspective view illustrating an inner cover unit of a screw fixing type included in an impact rotary tool according to a second variation;

FIG. 9 is a cross-sectional view illustrating the inner cover unit of the screw fixing type included in the impact rotary tool according to the second variation;

FIG. 10 is a perspective view illustrating an inner cover unit of a retaining ring fixing type included in the impact rotary tool according to the second variation;

FIG. 11 is a cross-sectional view illustrating the inner cover unit of the retaining ring fixing type included in the impact rotary tool according to the second variation;

FIG. 12 is a perspective view illustrating an inner cover unit of a threaded case fixing type included in the impact rotary tool according to the second variation;

FIG. 13 is a cross-sectional view illustrating the inner cover unit of the threaded case fixing type included in the impact rotary tool according to the second variation;

FIG. 14 is a perspective view illustrating a hammer member included in an impact rotary tool according to a third variation; and

FIG. 15 is a cross-sectional view illustrating a main part of an impact rotary tool according to a fourth variation.

### DETAILED DESCRIPTION

An impact rotary tool according to an embodiment will now be described in detail with reference to the accompanying drawings. Note that the drawings to be referred to in the following description of embodiments are all schematic representations. Thus, the ratio of the dimensions of respective constituent elements illustrated on the drawings does not always reflect their actual dimensional ratio. Also, the configurations to be described in the embodiments below are only exemplary ones of various embodiments of the present disclosure and should not be construed as limiting. Rather, the exemplary embodiment may be readily modified in various manners depending on a design choice or any other factor without departing from the scope of the present disclosure.

### (Embodiment)

### (1) Overview

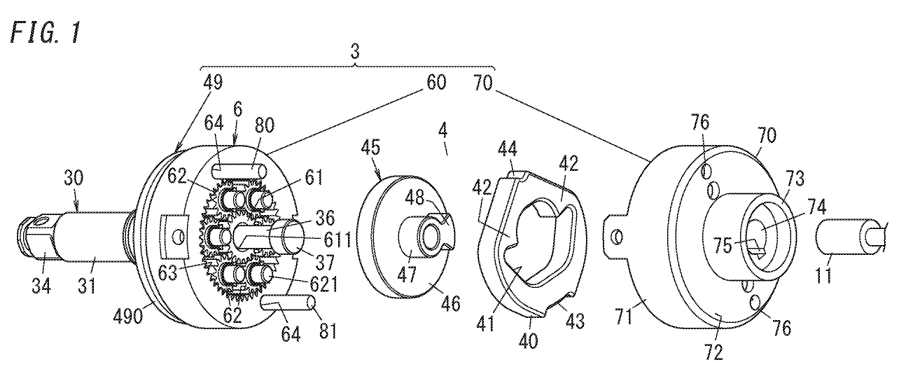

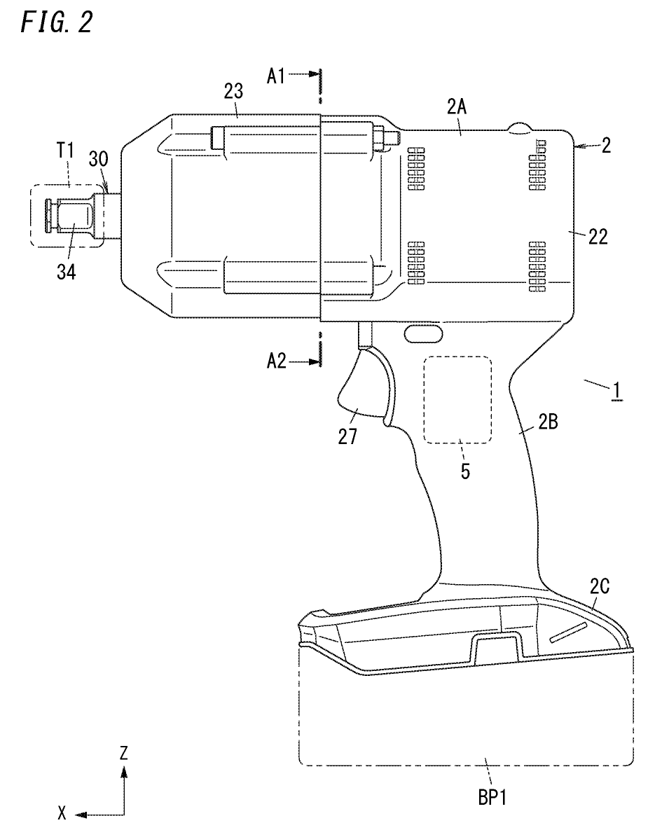

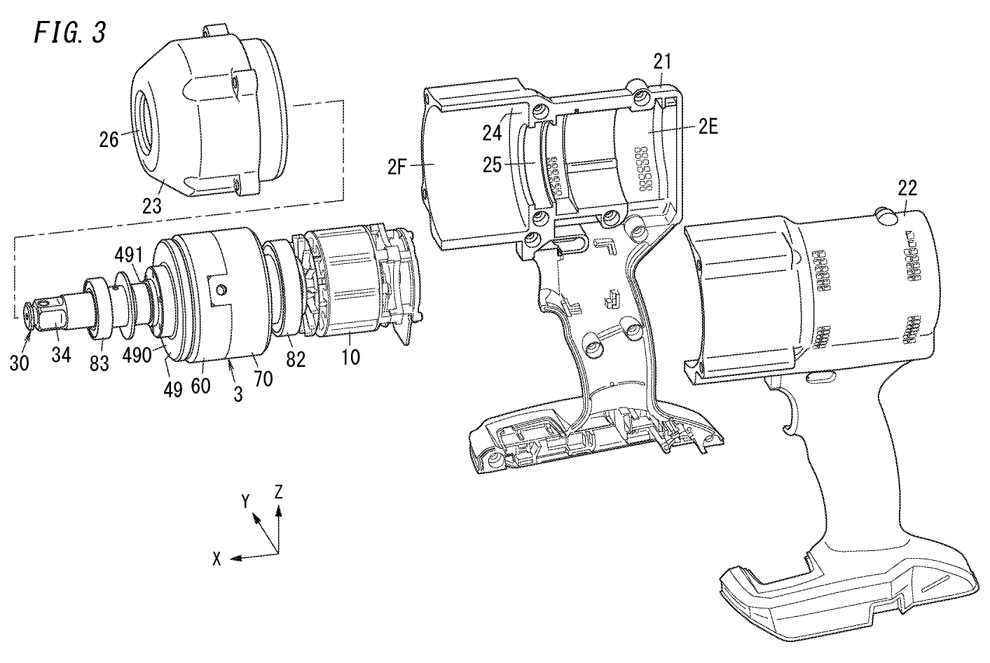

FIG. 1 is an exploded perspective view illustrating a main part of an impact rotary tool 1 according to this embodiment. FIG. 2 is a side view illustrating the impact rotary tool 1. FIG. 3 is an exploded perspective view illustrating the impact rotary tool 1.

The impact rotary tool 1 according to this embodiment includes a motor 10, an output shaft 30, a hit portion 48, a speed reducing mechanism 6, and an impact mechanism 4.

The motor 10 causes a rotary shaft 11 to rotate.

A tip tool T1 is attachable to the output shaft 30.

The hit portion 48 rotates together with the output shaft 30.

The speed reducing mechanism 6 decelerates the rotation of the rotary shaft 11 and transmits the decelerated rotation to the output shaft 30.

The impact mechanism 4 includes a hammer member 40 that rotates in response to the rotation of the rotary shaft 11 and hits the hit portion 48.

The impact mechanism 4 is disposed between the speed reducing mechanism 6 and the motor 10.

As used herein, the phrase “a tip tool T1 is attached to the output shaft 30” may refer to a situation where the tip tool T1 is attached directly to the output shaft 30 or a situation where the tip tool T1 is attached to the output shaft 30 via another member. Note that the tip tool T1 is not shown in FIG. 2 but the tip tool T1 is indicated by a long dashed double-short dashed line. Also, the phrase “the hit portion 48 rotates together with the output shaft 30” hereinafter refers to a situation where the hit portion 48 rotates, at the same speed as the output shaft 30, about the rotational axis of the output shaft 30.

In the impact rotary tool 1 according to this embodiment, since the speed reducing mechanism 6 decelerates the rotation of the rotary shaft 11 of the motor 10 and transmits the decelerated rotation to the output shaft 30, the hit portion 48 rotates at the speed thus reduced by the speed reducing mechanism 6. In addition, the hammer member 40 rotates in response to the rotation of the rotary shaft 11 to hit the hit portion 48, thus causing the output shaft 30 to rotate. In this case, the hit portion 48 rotates at the speed reduced by the speed reducing mechanism 6 as described above, which reduces the impulse applied to the hit portion 48 compared with a situation where the hit portion 48 that stays still is hit by the hammer member 40. This allows for providing the impact rotary tool 1 which may reduce the hitting sound.

### (2) Details

The impact rotary tool 1 according to this embodiment will now be described in detail with reference to FIGS. 1-6. In the following description, an X-axis direction (i.e., a direction in which the output shaft 30 protrudes from a body case 2 of the impact rotary tool 1) shown in FIG. 2 and other drawings will be referred to as a forward/backward direction, a Y-axis direction will be referred to as a rightward/leftward direction, and a Z-axis direction will be referred to as an upward/downward direction. Furthermore, the positive direction of the X-axis direction will be referred to as a front side, the positive direction of the Y-axis direction will be referred to as a right side, and the positive direction of the Z-axis direction will be referred to as an upper side. Note that these are exemplary directions and should not be construed as defining the direction when the impact rotary tool 1 is used. Also, arrows indicating respective directions in the drawings are only designated for the description and do not necessarily have substantive configurations.

### (2.1) Configurations

The impact rotary tool 1 according to this embodiment is a portable electric tool. The impact rotary tool 1 is used, for example, for the operations of either tightening or loosening the fastening member such as a bolt or a screw.

The impact rotary tool 1 according to this embodiment includes, as described above, the motor 10, the output shaft 30, the hit portion 48, the speed reducing mechanism 6, and the impact mechanism 4. Also, the impact rotary tool 1 further includes a body case 2 and an inner cover unit 3. The body case 2 houses the motor 10, the output shaft 30, the hit portion 48, the speed reducing mechanism 6, and the impact mechanism 4. The inner cover unit 3 is housed in the body case 2 and covers the speed reducing mechanism 6 and the impact mechanism 4. In other words, the inner cover unit 3 houses the speed reducing mechanism 6 and the impact mechanism 4.

### (2.1.1) Body Case

The body case 2 houses the motor 10, the output shaft 30, the hit portion 48, the impact mechanism 4, the speed reducing mechanism 6, and the inner cover unit 3 (refer to FIGS. 2 and 3). Also, the body case 2 further houses a control circuit 5 and other members (refer to FIG. 2).

The body case 2 is formed by assembling a right case 21, a left case 22, and a front case 23 as shown in FIG. 3. The body case 2 includes a housing portion 2A, a grip portion 2B, and an attached portion 2C with the right case 21, the left case 22, and the front case 23 assembled together (refer to FIG. 2).

The housing portion 2A has a hollow and cylindrical shape. A partition wall 24 divides the housing portion 2A in two rooms, namely a first housing room 2E in the rear side and a second housing room 2F in the front side. In the first housing room 2E, the motor 10 is housed, for example. In the second housing room 2F, the output shaft 30, the impact mechanism 4, the speed reducing mechanism 6, and the inner cover unit 3 are housed, for example. In the partition wall 24, a recess portion 25 is provided. The recess portion 25 forms (a part of) a penetration hole through which the rotary shaft 11 of the motor 10 passes when the right case 21 and the left case 22 are assembled together. Also, in the front case 23, a round hole 26 is provided to allow a tip portion of the output shaft 30 to pass therethrough.

The grip portion 2B protrudes from the outer peripheral surface of the housing portion 2A toward one direction aligned with a radial direction of the housing portion 2A. The one direction is, for example, aligned with the upward/downward direction (refer to FIGS. 2 and 3). The grip portion 2B is formed in a hollow and cylindrical shape having a longitudinal axis along the one direction. A worker may perform the operations such as tightening a screw by gripping the grip portion 2B. An operating member 27 is disposed on the grip portion 2B to accept an operating command entered by the worker.

The inner space of the grip portion 2B is connected to the inner space of the housing portion 2A. A first end of the longitudinal axis of the grip portion 2B is connected to the housing portion 2A, and a second end of the longitudinal axis of the grip portion 2B is connected to the attached portion 2C.

A battery pack BP1 is removably attached to the attached portion 2C. Note that the battery pack BP1 is not shown in FIG. 3 but the battery pack BP1 is indicated by a long dashed double-short dashed line. The impact rotary tool 1 is energized by the battery pack BP1. That is to say, the battery pack BP1 is a power supply supplying a current for driving the motor 10. The battery pack BP1 is not a constituent element of the impact rotary tool 1. The impact rotary tool 1 may, however, include the battery pack BP1.

### (2.1.2) Motor

The motor 10 is housed in the housing portion 2A (more particularly, in the first housing room 2E) of the body case 2. The motor 10 is, for example, a brushless motor. The rotary shaft 11 of the motor 10 protrudes into the second housing room 2F through the recess portion 25. At the tip of the rotary shaft 11, a key groove (not shown) is provided, for example.

The torque and rotational speed of the motor 10 are controlled, for example, by the control circuit 5 (refer to FIG. 2). The control circuit 5 is housed, for example, in the grip portion 2B.

When a worker performs the operations using the impact rotary tool 1, he/she operates the operating member 27 disposed on the grip portion 2B. For example, the operating member 27 is a so-called “trigger switch” and he/she enters an operating command by pulling the operating member 27. The control circuit 5 determines a target value of the rotational speed of the motor 10 depending on how deep the operating member 27 is pulled. The deeper the operating member 27 is pulled, the greater the control circuit 5 sets the target value of the rotational speed of the motor 10. Note that a driving circuit for driving the motor 10 is housed inside the body case 2. The driving circuit causes the motor 10 to rotate at the rotational speed in accordance with the control signal received from the control circuit 5.

### (2.1.3) Output Shaft

The output shaft 30 includes a shaft body 31 that is made of metallic material and that has the shape of a cylinder of which the central axis is aligned with the forward/backward direction, for example. A connecting portion 34 having the shape of a prism is provided at the front end of the shaft body 31. The connecting portion 34 of the output shaft 30 is exposed to the outside through the round hole 26 of the front case 23.

The tip tool T1 is attached to the connecting portion 34 of the output shaft 30. The tip tool T1 is, for example, a screwdriver bit or a socket bit. The screwdriver bit and the socket bit are bits for use to either tighten or loosen the fastening member such as bolts. A tip tool T1 among various types of tip tools T1 is attached to the output shaft 30 depending on an intended use.

Note that a holder member for holding the tip tool T1 may be attached to the connecting portion 34. The tip tool T1 may also be attached to the connecting portion 34 via the holder member.

The rear portion of the shaft body 31 is connected to a sun gear 61 included in the speed reducing mechanism 6, and the shaft body 31 rotates together with the sun gear 61.

### (2.1.4) Speed Reducing Mechanism and Inner cover unit

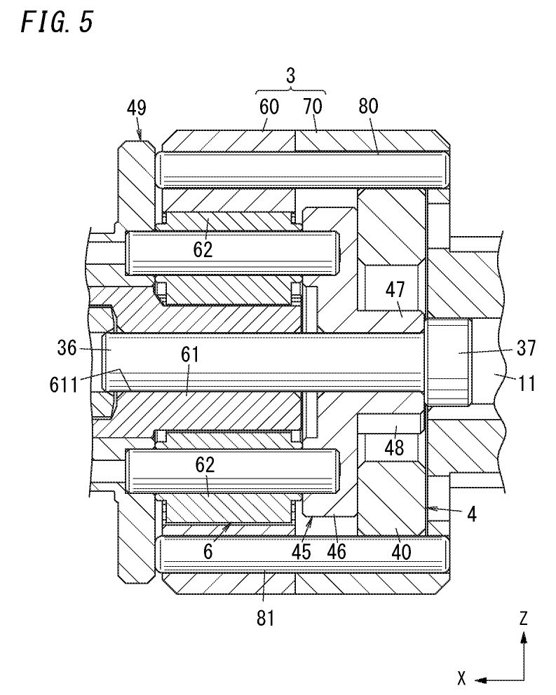

The speed reducing mechanism 6 is housed in the housing portion 2A (more particularly, in the second housing room 2F) of the body case 2. The speed reducing mechanism 6 includes the sun gear 61, a plurality of (e.g., six in the example illustrated in FIG. 5) planetary gears 62, an internal gear 63, a planetary carrier 45, a shaft supporting member 49, and a cover body 70.

The sun gear 61 is connected to the rear end portion of the output shaft 30. The central axis of the sun gear 61 is aligned with the central axis of the output shaft 30, and the sun gear 61 rotates together with the output shaft 30. A round hole 611 is provided in the rear end surface of the sun gear 61, and a shaft 36 for a centering is inserted into the round hole 611 (refer to FIG. 1).

The plurality of planetary gears 62 are arranged around the sun gear 61. The plurality of planetary gears 62 are arranged at the same intervals on a circle, of which the center is defined by the central axis of the sun gear 61. Each of the plurality of planetary gears 62 is an external gear. Each of the plurality of planetary gears 62 engages with the sun gear 61 and the internal gear 63.

The internal gear 63 has teeth provided on the inner peripheral surface of a circular cylindrical portion 60. The circular cylindrical portion 60 has a thickness smaller than the diameter. The plurality of planetary gears 62 are arranged on the inner peripheral surface of the circular cylindrical portion 60. The teeth of the internal gear 63 are arranged to surround the plurality of planetary gears 62 and engage with the plurality of planetary gears 62. In the circular cylindrical portion 60, two penetration holes 64, into which the front end portions of two cam pins 80 and 81 (to be described later) are respectively inserted, are respectively provided in positions symmetrical with respect to the central axis of the circular cylindrical portion 60.

The planetary carrier 45 and the shaft supporting member 49 support the plurality of planetary gears 62 in the state that each of the plurality of planetary gears 62 is ready to rotate about its axis. Each of the planetary gears 62 is supported between the planetary carrier 45 and the shaft supporting member 49 to be ready to rotate about its shaft 621.

The planetary carrier 45 is disposed on the back side of the circular cylindrical portion 60 for which the internal gear 63 is provided. The planetary carrier 45 includes a rotating plate 46 having the shape of a circular plate. A plurality of shaft holes, into which the shafts 621 of the plurality of planetary gears 62 are respectively inserted, are provided in the front surface of the rotating plate 46. A cylindrical portion 47 having the shape of a circular cylinder is provided in the center of the back surface of the rotating plate 46. The shaft 36 is inserted from behind into a hole of the cylindrical portion 47, and the tip of the shaft 36 is inserted into the round hole 611 of the sun gear 61. The shaft 36 aligns the central axis of the sun gear 61 with the central axis of the planetary carrier 45. Also, the hit portion 48 protrudes from the periphery of the cylindrical portion 47 to be aligned with a radial direction of the cylindrical portion 47. The hit portion 48 is provided as an integrated member with the rotating plate 46 and the cylindrical portion 47. The shape of the hit portion 48 is a fan when the hit portion 48 is viewed from the back.

The shaft supporting member 49 is disposed on the front side of the internal gear 63. The shaft supporting member 49 includes a rotating plate 490 having the shape of a circular plate. A circular cylindrical portion 491 protruding forward is provided in the center of the front surface of the rotating plate 490. The shaft body 31 of the output shaft 30 is inserted into a hole of the circular cylindrical portion 491.

In this case, the planetary carrier 45 is disposed on the rear side of the circular cylindrical portion 60 for which the internal gear 63 is provided, and the shaft supporting member 49 is disposed on the front side of the circular cylindrical portion 60. With this structure, the plurality of planetary gears 62 are supported between the planetary carrier 45 and the shaft supporting member 49 in the state that the plurality of planetary gears 62 are ready to rotate.

The cover body 70 is attached on the back side of the circular cylindrical portion 60 for which the internal gear 63 is provided in such a manner that the cover body 70 covers the planetary carrier 45. Note that the circular cylindrical portion 60 and the cover body 70 are joined together by using the fastening member such as a screw. However, this should not be construed as limiting. How to join the circular cylindrical portion 60 and the cover body 70 may be changed as appropriate.

The cover body 70 includes: a cylindrical portion 71 having the shape of a circular cylinder; and a rear wall 72 having the shape of a circular plate and closing the rear end portion of the cylindrical portion 71. A circular cylindrical portion 73 protruding backward is provided in the center of the back surface of the rear wall 72. A penetration hole 74 penetrating through the circular cylindrical portion 73 in the forward/backward direction is provided in the center of the circular cylindrical portion 73. A key groove 75 is provided in the inner peripheral surface of the penetration hole 74. A key is inserted into the key groove 75 provided in the inner peripheral surface of the penetration hole 74 and the key groove provided for the rotary shaft 11 of the motor 10, thus the rotary shaft 11 and the cover body 70 rotate together. Also, in the rear wall 72, two penetration holes 76 are respectively provided in positions symmetrical with respect to the central axis of the circular cylindrical portion 73. The rear end portions of the two cam pins 80 and 81 are inserted into the two penetration holes 76, respectively.

The cover body 70 is attached on the rear side of the circular cylindrical portion 60 for which the internal gear 63 is provided, thereby both the cover body 70 and the circular cylindrical portion 60 rotate together with the rotary shaft 11.

When the circular cylindrical portion 60 and thus the internal gear 63 rotates, the planetary gears 62 rotate, and the rotations of the planetary gears 62 are transmitted to the sun gear 61, thus the sun gear 61 rotates. Also, the plurality of planetary gears 62 revolve around the sun gear 61, thereby the plurality of planetary gears 62, the planetary carrier 45, and the shaft supporting member 49 rotate about the sun gear 61.

In this embodiment, the space surrounded by the cover body 70, the circular cylindrical portion 60, and the shaft supporting member 49 houses: the sun gear 61 and the plurality of planetary gears 62, which belong to the speed reducing mechanism 6; and the hit portion 48, the hammer member 40, and the cam pins 80, 81, which belong to the impact mechanism 4. That is to say, the circular cylindrical portion 60, the shaft supporting member 49, and the cover body 70 constitute the inner cover unit 3 that houses the speed reducing mechanism 6 and the impact mechanism 4. The circular cylindrical portion 60 rotates in response to the rotation of the rotary shaft 11 of the motor 10 as described above, and therefore the inner cover unit 3 rotates in response to the rotation of the rotary shaft 11. Energy generated by the impact can be converted into inertial energy by the rotation of the inner cover unit 3. This allows for increasing the output torque.

Note that in this embodiment, the inner cover unit 3 is constituted by multiple members assembled together. The inner cover unit 3 has the shape of a circular cylinder overall. In this embodiment, the inner cover unit 3 is obtained by assembling the multiple members, namely, the circular cylindrical portion 60, the shaft supporting member 49, and the cover body 70. The inner cover unit 3 constituted by the multiple members assembled together allows for making it easier to perform the operations to put the impact mechanism 4 and the speed reducing mechanism 6 inside the inner cover unit 3. Note that the circular cylindrical portion 60 is fixed and fastened to the cover body 70 with the fastening member such as a screw.

In addition, a lubricant (not shown) is filled inside the inner cover unit 3. That is to say, the impact rotary tool 1 further includes the lubricant filled inside the inner cover unit 3. The lubricant is, for example, lubricating grease for helping a machine to move smoothly and is filled in the contact areas of the hit portion 48 and the hammer member 40. Filling the contact areas of the hit portion 48 and the hammer member 40 with the lubricant allows for reducing the chances of the occurrence of wear by the impact. Furthermore, the lubricant is filled in the contact areas of the sun gear 61, the plurality of planetary gears 62, and the internal gear 63, which belong to the speed reducing mechanism 6. Filling the contact areas of the sun gear 61, the plurality of planetary gears 62, and the internal gear 63 with the lubricant allows for reducing wear on the gears. Note that in the impact rotary tool 1 according to this embodiment, the inside of the inner cover unit 3 does not have to be filled by the lubricant but the lubricant may be omitted as appropriate.

### (2.1.5) Impact Mechanism

The impact mechanism 4 is housed in the housing portion 2A (more particularly, in the second housing room 2F) of the body case 2. The impact mechanism 4 receives the rotational force from the motor 10, thereby hitting the hit portion 48 that rotates together with the output shaft 30, thus applying the impacting force to the output shaft 30.

The impact mechanism 4 includes the hammer member 40, the two cam pins 80 and 81, and the cover body 70 described above. Also, the impact mechanism 4 further includes the hit portion 48 that rotates together with the output shaft 30. The impact mechanism 4 is disposed between the speed reducing mechanism 6 and the motor 10. More particularly, the impact mechanism 4 and the speed reducing mechanism 6 are arranged to be adjacent to each other as shown in FIG. 5. As used herein, the phrase “the impact mechanism 4 and the speed reducing mechanism 6 are arranged to be adjacent to each other” refers that no other members are interposed between the members belonging to the impact mechanism 4 and the members belonging to the speed reducing mechanism 6. In the impact rotary tool 1 according to this embodiment, the impact mechanism 4 and the speed reducing mechanism 6 are adjacent to each other, which contributes to reducing the size of the impact rotary tool 1 compared with a situation where another member is interposed between the impact mechanism 4 and the speed reducing mechanism 6. However, this should not be construed as limiting. Optionally, one or more other members may be interposed between the members belonging to the impact mechanism 4 and the members belonging to the speed reducing mechanism 6.

The two cam pins 80 and 81 are round bars which are made of metal and have the same diameter and total length. The front end portions of the cam pins 80 and 81 are inserted respectively into the two penetration holes 64 in the circular cylindrical portion 60 for which the internal gear 63 is provided. The rear end portions of the cam pins 80 and 81 are inserted respectively into the two penetration holes 76 provided in the rear wall 72 of the cover body 70.

The hammer member 40 is formed in the shape of an oval when viewed from the front. An insertion hole 41, into which the cylindrical portion 47 provided with the hit portion 48 is inserted, is provided in the center of the hammer member 40. The hammer member 40 has the shape of a hollow cylinder and is provided with the insertion hole 41 into which the hit portion 48 is inserted.

A first groove 43 into which the cam pin 81 is inserted and a second groove 44 into which the cam pin 80 is inserted are provided on the outer peripheral surface of the hammer member 40 to face each other with the insertion hole 41 interposed therebetween. Hereinafter, the cam pin (cam pin 81) inserted into the first groove 43 of the hammer member 40 will also be referred to as a “first cam pin”, and the cam pin (cam pin 80) inserted into the second groove 44 of the hammer member 40 will also be referred to as a “second cam pin. The first groove 43 is formed to have a width larger than the diameter of the cam pin 81 (serving as the first cam pin). The second groove 44 is formed to have a groove width as large as the diameter of the cam pin 80 (serving as the second cam pin). In addition, two hitting portions 42 are provided on the inner surface of the insertion hole 41 at positions closer to the second groove 44 than the first groove 43 with the second groove 44 interposed therebetween. The two hitting portions 42 are provided to protrude inward from the inner surface of the insertion hole 41.

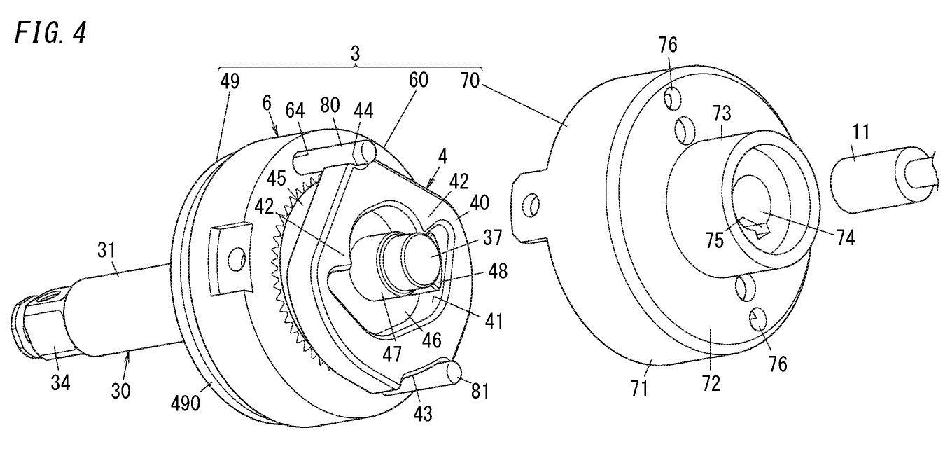

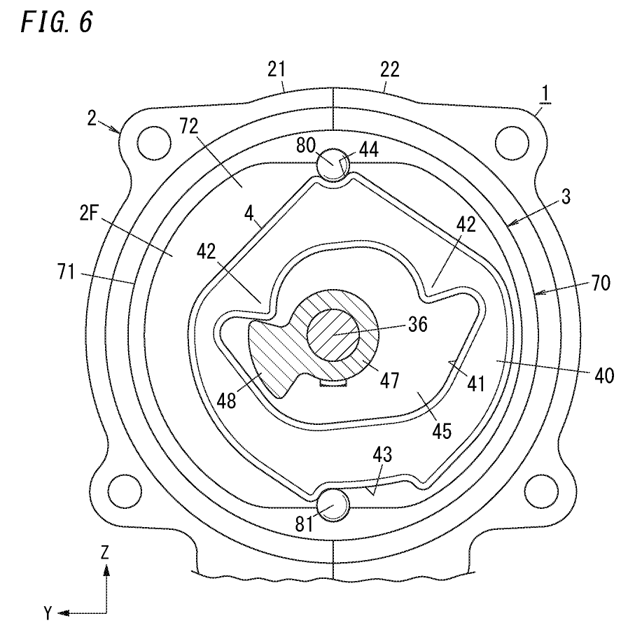

As shown in FIGS. 4 and 6, the hammer member 40 is housed inside the inner cover unit 3 in such a manner that the cam pin 81 (serving as the first cam pin) is inserted into the first groove 43 and the cam pin 80 (serving as the second cam pin) is inserted into the second groove 44. That is to say, the first groove 43 and the second groove 44, into which the cam pin 80 (serving as the first cam pin) and cam pin 81 (serving as the second cam pin) fixed to the inner cover unit 3 are respectively inserted, are provided for the hammer member 40. The first groove 43 has a width larger than the diameter of the cam pin 81 (serving as the first cam pin).

The cover body 70 is joined to the rotary shaft 11 of the motor 10, thus rotating in response to the rotation of the rotary shaft 11. The hammer member 40 is supported between the two cam pins 80 and 81 attached between the cover body 70 and the circular cylindrical portion 60. Therefore, the hammer member 40 rotates as the cover body 70 and the circular cylindrical portion 60 rotate in response to the rotation of the rotary shaft 11. That is to say, the hammer member 40 rotates in response to the rotation of the rotary shaft 11. Note that the hammer member 40 is allowed to rotate (swing) around the cam pin 80 (serving as the second cam pin) inserted into the second groove 44 within the range that the cam pin 81 (serving as the first cam pin) is allowed to move within the first groove 43.

Also, when the circular cylindrical portion 60 rotates, the plurality of planetary gears 62 engaging with the internal gear 63 provided for the circular cylindrical portion 60 rotates about the sun gear 61, thus the planetary carrier 45 for which the hit portion 48 is provided rotates in response to the revolution of the plurality of planetary gears 62. In this case, the planetary carrier 45 rotates at a speed decelerated according to the reduction ratio of the speed reducing mechanism 6 to the rotational speed of the circular cylindrical portion 60, and therefore, the rotational speed of the hammer member 40 is relatively faster than that of the hit portion 48. That is to say, the hammer member 40 rotates relatively faster than the hit portion 48, thus the hit portion 48 is hit by the hitting portion 42 of the hammer member 40.

### (2.2) Description of How to Assemble

As can be seen from the foregoing description, the motor 10, the output shaft 30, the impact mechanism 4, the speed reducing mechanism 6, the inner cover unit 3, the control circuit 5, and other members are housed inside the body case 2 of the impact rotary tool 1.

In this embodiment, the impact mechanism 4, the speed reducing mechanism 6, and the inner cover unit 3 are assembled in the following process. Note that the assembling procedure to be described below is only an example and should not be construed as limiting. Rather, some process steps of this procedure may be performed in a different order from the one to be described below.

For example, an assembling worker disposes the plurality of planetary gears 62 and the sun gear 61 inside the internal gear 63 provided for the circular cylindrical portion 60. The assembling worker disposes the shaft supporting member 49 on the front side of the circular cylindrical portion 60 and also disposes the planetary carrier 45 on the rear side of the circular cylindrical portion 60, thereby the plurality of planetary gears 62 are supported between the shaft supporting member 49 and the planetary carrier 45 in the state that each of the plurality of planetary gears 62 is ready to rotate about its axis. Then, the assembling worker inserts the shaft 36 into the hole of the cylindrical portion 47 of the planetary carrier 45 from behind, thereby performing a centering to align the central axes of the sun gear 61, the output shaft 30, and the planetary carrier 45 to each other. Note that a large diameter portion 37 having a larger diameter than the diameter of the remaining portion of the shaft 36 is provided at the rear end portion of the shaft 36. The shaft 36 is inserted into the hole of the cylindrical portion 47 until the large diameter portion 37 comes to contact with the rear end of the cylindrical portion 47 (refer to FIG. 4).

Next, the assembling worker respectively inserts the cam pins 80 and 81 into the two penetration holes 64 of the circular cylindrical portion 60 such that the cam pin 81 (serving as the first cam pin) is inserted into the first groove 43 and the cam pin 80 (serving as the second cam pin) is inserted into the second groove 44. As a result, the hammer member 40 is held between the two cam pins 80 and 81. Then, the assembling worker fills the inside of the circular cylindrical portion 60 and the cover body 70 with the lubricant and then attaches the cover body 70 on the rear side of the circular cylindrical portion 60 to join the circular cylindrical portion 60 and the cover body 70 together. In this step, the inner cover unit 3 as an assemblage of the circular cylindrical portion 60, the cover body 70, and the shaft supporting member 49 is formed in such a state that the impact mechanism 4 and the speed reducing mechanism 6 are housed inside the inner cover unit 3.

Thereafter, the assembling worker inserts the rotary shaft 11 of the motor 10 into the penetration hole 74 of the cover body 70 and also inserts the key into the key groove 75 provided in the inner peripheral surface of the penetration hole 74 and the key groove provided for the rotary shaft 11, thus jointing the rotary shaft 11 and the cover body 70. Also, the assembling worker connects the output shaft 30 to the sun gear 61 of the speed reducing mechanism 6.

Finally, the assembling worker inserts the motor 10 into the first housing room 2E of the right case 21 and also inserts the inner cover unit 3 that has housed the impact mechanism 4 and the speed reducing mechanism 6 into the second housing room 2F of the right case 21. Also, after disposing the control circuit 5, the operating member 27, and other members in the grip portion 2B of the right case 21, the assembling worker puts the left case 22 over the right case 21, and fastens the right case 21 and the left case 22 together with the fastening member such as a screw or a bolt. Then, the assembling worker attaches the front case 23 to the assemblage of the right case 21 and the left case 22 to close the opening which is formed at the front end portion of the assemblage of the right case 21 and the left case 22 and then fastens the right case 21, the left case 22, and the front case 23 together with the fastening member such as a screw or a bolt. In this case, the tip of the output shaft 30 protrudes forward from the round hole 26 of the front case 23. Note that a bearing 82 (refer to FIG. 3) is attached to the rotary shaft 11 of the motor 10. The rotary shaft 11 of the motor 10 is supported by the right case 21 and the left case 22 via the bearing 82 in the state that the rotary shaft 11 of the motor 10 is ready to rotate. Also, a bearing 83 (refer to FIG. 3) is attached to the output shaft 30. The output shaft 30 is supported by the front case 23 via the bearing 83 in the state that the output shaft 30 is ready to rotate.

The impact rotary tool 1 can be assembled through the procedure described above. After that, when the battery pack BP1 is attached to the attached portion 2C, the battery pack BP1 is ready to supply electric power to, for example, the control circuit 5. Therefore, the worker can perform the operations using the impact rotary tool 1.

### (2.3) Description of operations

When the worker, who performs the fastening operations using the impact rotary tool 1, pulls the operating member 27 of the impact rotary tool 1, the control circuit 5 determines a target value of the rotational speed of the motor 10 according to how deep the operating member 27 is pulled, and then outputs a control signal to the driving circuit. The driving circuit controls the electric power to be supplied to the motor 10 in accordance with the control signal output by the control circuit 5, thus causing the motor 10 to rotate. In a particular setting where the rotary shaft 11 of the motor 10 rotates counterclockwise when viewed from the front, the cover body 70 and the circular cylindrical portion 60 rotate counterclockwise, when viewed from the front, in response to the rotation of the rotary shaft 11. Since the cam pins 81 and 80 attached between the cover body 70 and the circular cylindrical portion 60 are respectively inserted into the first groove 43 and second groove 44 of the hammer member 40, the hammer member 40 rotates in response to the rotation of the cover body 70 and the circular cylindrical portion 60.

As described above, in the speed reducing mechanism 6, the plurality of planetary gears 62 engage with the internal gear 63 provided for the circular cylindrical portion 60 and the sun gear 61. Therefore, in response to the rotation of the internal gear 63, each of the plurality of planetary gears 62 revolves around the sun gear 61 while rotating about its axis, and thus the sun gear 61 rotates. As a result, the output shaft 30 joined to the sun gear 61 rotates at a decelerated rotational speed, which is obtained by decelerating a rotational speed of the rotary shaft 11 of the motor 10 according to the reduction ratio of the speed reducing mechanism 6. Also, as the plurality of planetary gears 62 revolve around the sun gear 61, the planetary carrier 45 for which the hit portion 48 is provided rotates. In this embodiment, the rotational speed of the planetary carrier 45 is slower than that of the rotary shaft 11 of the motor 10 because the rotational speed of the planetary carrier 45 is decelerated by the speed reducing mechanism 6. As a result, the rotational speed of the hammer member 40 is faster than that of the planetary carrier 45. Thus, the hammer member 40 rotates relative to the planetary carrier 45, thereby the hitting portion 42 on the left side of the hammer member 40 strikes the hit portion 48. Note that, in the embodiment, the hammer member 40 is allowed to swing around the cam pin 80 (serving as the second cam pin) inserted into the second groove 44 within the range that the cam pin 81 (serving as the first cam pin) is allowed to move within the first groove 43. Therefore, the hammer member 40 swings around the cam pin 80 (serving as the second cam pin), which is inserted into the second groove 44, in one direction until the cam pin 81 (serving as the first cam pin) reaches one end of the first groove 43. Thereafter, when the hammer member 40 further rotates counterclockwise in response to the rotation of the cover body 70, the hitting portion 42 climbs over the hit portion 48 and then the inner peripheral surface of the insertion hole 41 is pushed by the hit portion 48, thus the hammer member 40 swings around the cam pin 80 (serving as the second cam pin), which is inserted into the second groove 44, in another direction opposite from the one direction described above.

In such a manner, when the circular cylindrical portion 60 and the cover body 70 rotate in response to the rotation of the rotary shaft 11 of the motor 10, the rotational speed, which is decelerated by the speed reducing mechanism 6, of the rotary shaft 11 is transmitted to the output shaft 30. Therefore, the output shaft 30 rotates at a rotational speed decelerated by the speed reducing mechanism 6. Also, when the hitting portion 42 of the hammer member 40 hits the hit portion 48 in response to the rotation of the circular cylindrical portion 60 and the cover body 70, the impacting force is applied to the output shaft 30. This allows for providing the impact rotary tool 1 with high torque, thus the operations such as tightening or loosening the fastening member is performed by using the tip tool T1 held by the output shaft 30.

Note that in another setting where the rotary shaft 11 of the motor 10 rotates clockwise when viewed from the front, the hit portion 48 is hit by the other hitting portion 42 of the hammer member 40 as opposed to the one that hits the hit portion 48 in the setting described above where the rotary shaft 11 rotates counterclockwise when viewed from the front.

### (3) Variations

Note that the embodiment described above is only an exemplary one of various embodiments of the present disclosure and should not be construed as limiting. Rather, the exemplary embodiment described above may be readily modified in various manners depending on a design choice or any other factor without departing from the scope of the present disclosure.

Next, variations of the exemplary embodiment will be enumerated one after another. Note that the variations to be described below may be adopted in combination as appropriate. Note that in the following description, the embodiment described above will be referred to as a basic configuration.

### (3.1) First Variation

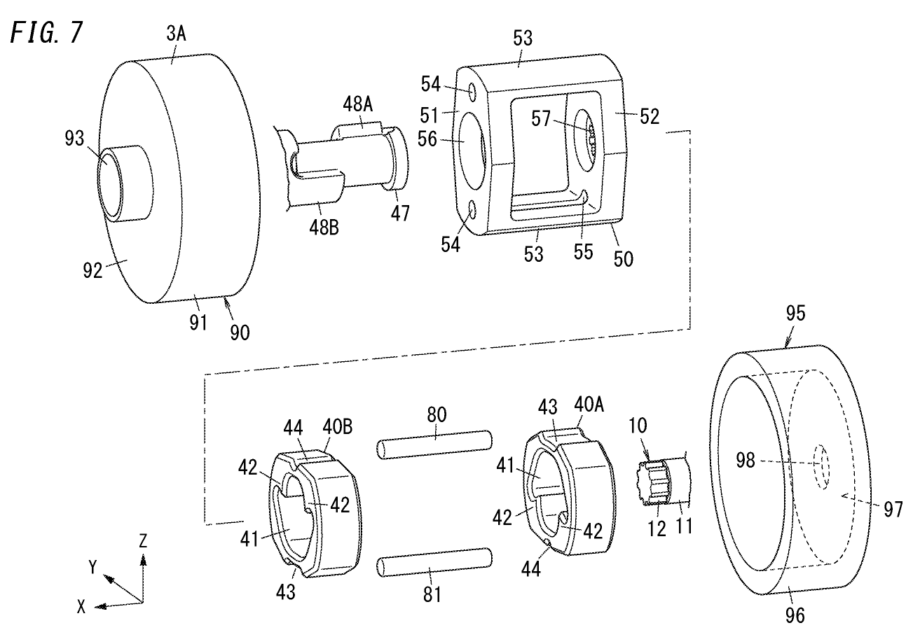

An impact rotary tool 1 according to a first variation will be described with reference to FIG. 7.

In the impact rotary tool 1 according to the first variation, two hit portions 48A and 48B are provided for a cylindrical portion 47 of a planetary carrier 45 and an impact mechanism 4 includes two hammer members 40A and 40B and a cam case 50, which are differences from the impact rotary tool 1 according to the basic configuration. In addition, in the impact rotary tool 1 according to the first variation, an inner cover unit 3A covering the impact mechanism 4 and a speed reducing mechanism 6 is fixed to a body case 2, which is another difference from the impact rotary tool 1 according to the basic configuration. Note that constituent elements of the impact rotary tool 1 according to the first variation having the same feature as the basic configuration will be designated by the same reference sign and description thereof will be omitted herein to avoid redundancy.

The cam case 50 is formed to have a frame shape with: a pair of first plate pieces 51 and 52 facing each other in a direction aligned with the axis of the cylindrical portion 47 of the planetary carrier 45; and a pair of second plate pieces 53 and 53 for joining end portions of the pair of first plate pieces 51 and 52.

Each of the pair of first plate pieces 51 and 52 has the shape of a rectangular plate.

A penetration hole 56, into which the cylindrical portion 47 of the planetary carrier 45 is inserted, is provided in the middle portion of a longitudinal axis of the first plate piece 51. Also, two penetration holes 54 are provided for the first plate piece 51 in positions symmetrical with respect to the center of the penetration hole 56. First ends (i.e., the front end portions) of respective longitudinal axes of two cam pins 80 and 81 are inserted one to one into the two penetration holes 54 of the first plate piece 51.

A penetration hole 57, into which the cylindrical portion 47 of the planetary carrier 45 is inserted, is provided in the middle portion of a longitudinal axis of the first plate piece 52. Also, two penetration holes 55 are provided for the first plate piece 52 in positions symmetrical with respect to the center of the penetration hole 57. Second ends (i.e., the rear end portions) of the respective longitudinal axes of two cam pins 80 and 81 are inserted one to one into the two penetration holes 55 of the first plate piece 52.

In the cam case 50, the cam pins 80 and 81 are inserted into the penetration holes 54 and 55 of the first plate pieces 51 and 52 with the two hammer members 40A and 40B inserted into the space between the pair of first plate pieces 51 and 52. In this case, the cam pin 80 is inserted into a first groove 43 of the hammer member 40A and a second groove 44 of the hammer member 40B. The cam pin 81 is inserted into a second groove 44 of the hammer member 40A and a first groove 43 of the hammer member 40B. That is, as to the hammer member 40A, the cam pin 80 serves as the “first cam pin” inserted into the first groove 43, and the cam pin 81 serves as the “second cam pin” inserted into the second groove 44. On the other hand, as to the hammer member 40B, the cam pin 81 serves as the “first cam pin” inserted into the first groove 43, and the cam pin 80 serves as the “second cam pin” inserted into the second groove 44. In other words, the first cam pin for the hammer member 40A also serves as the second cam pin for the hammer member 40B (i.e., the cam pin 80). Also, the first cam pin for the hammer member 40B also serves as the second cam pin for the hammer member 40A (i.e., the cam pin 81). .With this structure, the hammer member 40A is supported by the cam case 50 in the state that the hammer member 40A is allowed to swing around the cam pin 81 (serving as the second cam pin) inserted into the second groove 44. Also, the hammer member 40B is supported by the cam case 50 in the state that the hammer member 40B is allowed to swing around the cam pin 80 (serving as the second cam pin) inserted into the second groove 44. In addition, the hit portion 48A on the rear side is inserted into an insertion hole 41 of the hammer member 40A, and the hit portion 48B on the front side is inserted into an insertion hole 41 of the hammer member 40B.

A pinion gear 12 is provided for the rotary shaft 11 of the motor 10, and an internal gear that engages with the pinion gear 12 is provided for the rear portion of the penetration hole 57 of the first plate piece 52. As the rotary shaft 11 of the motor 10 rotates, the cam case 50 rotates together with the rotary shaft 11. The cam case 50 is joined to the circular cylindrical portion 60 described in the basic configuration. When the circular cylindrical portion 60 rotates in response to the rotation of the cam case 50, the output shaft 30 rotates at a speed decelerated by the speed reducing mechanism 6, thus the planetary carrier 45 for which the hit portions 48A and 48B are provided rotates. In response to the rotation of the cam case 50, the hammer members 40A and 40B supported by the cam case 50 also rotate. Thus, the hitting portion 42 of the hammer member 40A hits the hit portion 48A, and the hitting portion 42 of the hammer member 40B hits the hit portion 48B of the output shaft 30. In this manner, the rotation of the rotary shaft 11 of the motor 10 is transmitted to the output shaft 30 by the speed reducing mechanism 6 to cause the output shaft 30 to rotate, and the impacting force is applied to the output shaft 30 by the impact mechanism 4. This allows for providing the impact rotary tool 1 with high torque.

Also, contrary to the basic configuration where a member belonging to each of the speed reducing mechanism 6 and the impact mechanism 4 also serves as a member forming the inner cover unit 3, the impact rotary tool 1 according to the first variation includes an inner cover unit 3A constituted by other members which are different from the members belonging to the speed reducing mechanism 6 and the impact mechanism 4.

The inner cover unit 3A is constituted by a first cylindrical body 90 in the front part and a second cylindrical body 95 in the rear part assembled together. The first cylindrical body 90 is fixed and fastened to the second cylindrical body 95 with the fastening member such as a screw, for example. A lubricant (not shown) is filled inside the inner cover unit 3A. The lubricant is, for example, lubricating grease for helping a machine to move smoothly and is filled in the contact areas of the hit portions 48A and 48B and the hammer members 40A and 40B. Furthermore, the lubricant is filled in the contact areas of the sun gear 61, the plurality of planetary gears 62, and the internal gear 63, which belong to the speed reducing mechanism 6. Filling the contact areas of the hit portions 48A and 48B and the hammer members 40A and 40B with the lubricant allows for reducing the chances of the occurrence of wear by the impact. Also, filling the contact areas of the sun gear 61, the plurality of planetary gears 62, and the internal gear 63 with the lubricant allows for reducing wear on the gears.

The first cylindrical body 90 includes a circular cylindrical portion 91 having a circular cylindrical and hollow shape and a front wall 92 having a circular plate shape which closes the front end portion of the circular cylindrical portion 91. The first cylindrical body 90 is formed in the shape of a bottomed cylinder of which the front end portion is closed. A penetration hole 93 into which the output shaft 30 is inserted is provided in the center position of the front wall 92.

The second cylindrical body 95 includes a circular cylindrical portion 96 having a circular cylindrical and hollow shape and a back wall 97 having a circular plate shape which closes the rear end portion of the circular cylindrical portion 96. The second cylindrical body 95 is formed in the shape of a bottomed cylinder of which the rear end portion is closed. A round hole 98 through which the rotary shaft 11 of the motor 10 passes is provided in the center of the back wall 97.

The inner cover unit 3A is fixed to the body case 2. More particularly, the inner cover unit 3A, which houses the hammer members 40A and 40B, the cam case 50, the cam pins 80 and 81, the hit portions 48A and 48B provided for the planetary carrier 45, and the speed reducing mechanism 6, is fixed to the body case 2 by a method as appropriate. That is to say, the inner cover unit 3A is fixed to the body case 2 and does not rotate in response to the rotation of the rotary shaft 11 of the motor 10. This can reduce the load applied to the motor 10 compared with a situation where the inner cover unit 3 rotates in response to the rotation of the rotary shaft 11 of the motor 10. Note that the cam case 50 is housed inside the inner cover unit 3A in the state of being ready to rotate and rotates in response to the rotation of the rotary shaft 11 of the motor 10. Also, the circular cylindrical portion 60 is housed inside the inner cover unit 3A in the state of being ready to rotate and rotates in response to the rotation of the rotary shaft 11 of the motor 10.

In this case, the two hit portions 48A and 48B are respectively provided in positions symmetrical with respect to the rotational axis of the output shaft 30 (i.e., the central axis of the cylindrical portion 47). The impact mechanism 4 includes the two hammer members 40A and 40B correspond one to one to the two hit portions 48A and 48B. Each of the two hammer members 40A and 40B hits, in response to the rotation of the motor 10, the corresponding one of the two hit portions 48A and 48B.

More particularly, the two hit portions 48A and 48B are arranged to be aligned in the forward/backward direction on the cylindrical portion 47 of the planetary carrier 45. The two hit portions 48A and 48B protrude from the surface of the cylindrical portion 47 in the opposite direction from each other. The hit portion 48A is provided on the rear part of the surface of the cylindrical portion 47, and the hit portion 48B is provided on the front part of the surface of the cylindrical portion 47.

Each of the two hammer members 40A and 40B has substantially the same shape as the hammer member 40 described in the basic configuration, and therefore, description of the hammer members 40A and 40B will be omitted herein.

The two hammer members 40A and 40B are arranged in the forward/backward direction so that the hammer member 40A is disposed behind the hammer member 40B.

The hammer member 40A on the back side is supported by the cam case 50 with the cam pin 80 (serving as the first cam pin) inserted into the first groove 43 and the cam pin 81 (serving as the second cam pin) inserted into the second groove 44.

The hammer member 40B on the front side is supported by the cam case 50 with the cam pin 81 (serving as the first cam pin) inserted into the first groove 43 and the cam pin 80 (serving as the second cam pin) inserted into the second groove 44.

In the first variation, the two hammer members 40A and 40B hit the two hit portions 48A and 48B, which allows for applying the impacting force equally to the two hit portions 48A and 48B provided respectively in positions symmetrical with respect to the rotational axis of the cylindrical portion 47 of the planetary carrier 45. As a result, when the two hammer members 40A and 40B hit the two hit portions 48A and 48B, the impacting force is equally applied to the output shaft 30 joined to the sun gear 61, thus enabling the output shaft 30 to rotate smoothly.

Also, the respective hitting portions 42 of the two hammer members 40A and 40B hit the two hit portions 48A and 48B, which are provided respectively in positions symmetrical with respect to the rotational axis of the output shaft 30, at the same time, thus the impacting force is transmitted to the output shaft 30 evenly. This allows the output shaft 30 to rotate smoothly. Note that “the time at which the hitting portion 42 of the hammer member 40A hits the hit portion 48A and the time at which the hitting portion 42 of the hammer member 40B hits the hit portion 48B are the same time” is not limited to perfectly the same time. Alternatively, the time gap between the time at which the hitting portion 42 of the hammer member 40A hits the hit portion 48A and the time at which the hitting portion 42 of the hammer member 40B hits the hit portion 48B only needs to be at most equal to or less than 10 percent of the period of one cycle of the cam case 50.

The impact mechanism 4 is covered with the inner cover unit 3A also in the impact rotary tool 1 according to the first variation, which allows for reducing the hitting sound transmitted to the outside of the body case 2 if a hitting sound is generated when the hammer members 40A and 40B hit the hit portions 48A and 48B. In addition, the inner cover unit 3A allows for reducing the chances that the lubricant, which is filled in the inner cover unit 3A for helping the impact mechanism 4 and the speed reducing mechanism 6 to move smoothly, splashes. This makes it less easy for a lubricating effect of the lubricant to deteriorate. Thus, the impact rotary tool 1 according to the first variation allows for reducing the chances of wear of members belonging to the impact mechanism 4 and the speed reducing mechanism 6.

Note that in the impact rotary tool 1 according to the first variation, the inner cover unit 3A is fixed to the body case 2, which can reduce the load applied to the motor 10 compared with a situation where the inner cover unit 3A rotates in response to the rotation of the rotary shaft 11 of the motor 10.

Note that, the impact rotary tool 1 according to the basic configuration may be modified, as in the first variation, to include: the two hit portions 48A and 48B provided for the output shaft 30; and the two hammer members 40A and 40B that hit the two hit portions 48A and 48B.

Also, in the impact rotary tool 1 according to the basic configuration, as in the first variation, the inner cover unit 3A, which covers the speed reducing mechanism 6 and the impact mechanism 4, may also be fixed to the body case 2.

### (3.2) Second Variation

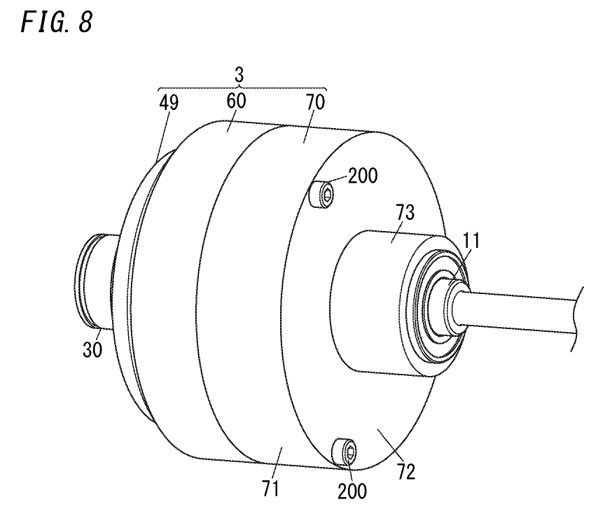

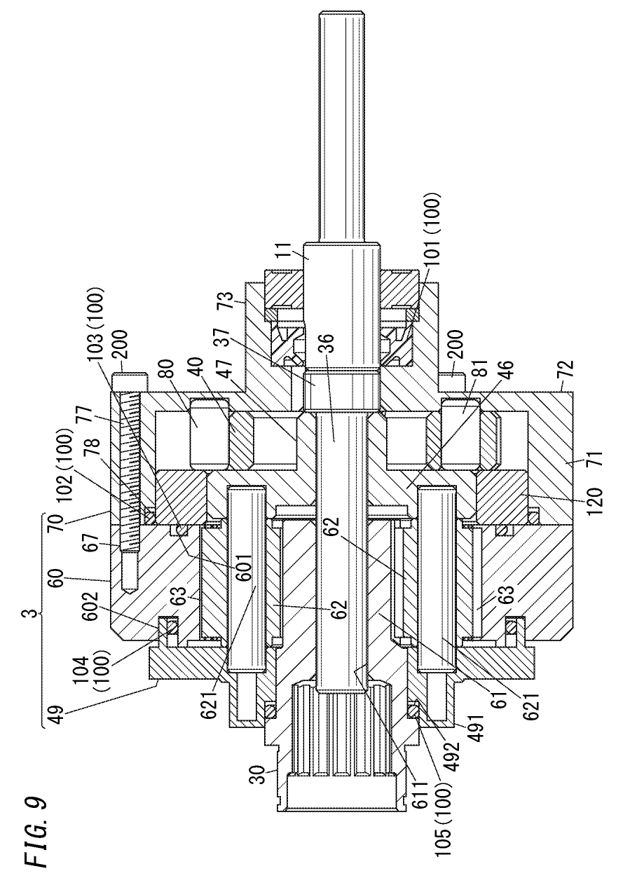

An impact rotary tool 1 according to a second variation will be described with reference to FIGS. 8 and 9. The impact rotary tool 1 according to the second variation further includes a sealing member 100 for sealing an inner cover unit 3, which is a difference from the impact rotary tool 1 according to the basic configuration. Note that the impact rotary tool 1 according to the second variation includes the same configuration as the basic configuration except for the inner cover unit 3 including the sealing member 100, and therefore, constituent elements of the impact rotary tool 1 according to the second variation having the same feature as the basic configuration will be designated by the same reference sign and description thereof will be omitted herein to avoid redundancy.

As used in the present disclosure, the phrase “seal” the inner cover unit 3 is not limited to seal the inner cover unit 3 in a strict sense of a word. Alternatively, the phrase “seal” the inner cover unit 3 may also refer to at least partially close gaps in the inner cover unit 3 so that the inner cover unit 3 has smaller gaps.

The inner cover unit 3 included in the impact rotary tool 1 according to the second variation includes, as described in the basic configuration, a circular cylindrical portion 60, a shaft supporting member 49 attached on the front side of the circular cylindrical portion 60, and a cover body 70 attached on the back side of the circular cylindrical portion 60.

In the inner cover unit 3 shown in FIGS. 8 and 9, the circular cylindrical portion 60 and the cover body 70 are fixed with three screws 200. For example, three penetration holes 77 penetrating through the cover body 70 along the forward/backward direction are separately provided for the cover body 70. Three screw holes 67 corresponding one to one to the three penetration holes 77 of the cover body 70 are provided for the circular cylindrical portion 60. By inserting the screws 200 into the penetration holes 77 of the cover body 70 and screwing into the screw holes 67 of the circular cylindrical portion 60, the circular cylindrical portion 60 and the cover body 70 are joined to each other. Note that the shaft supporting member 49 is fixed to the inner cover unit 3 or a body case 2 housing the inner cover unit 3 by a method as appropriate.

A rotary shaft 11 of a motor 10 is inserted into a circular cylindrical portion 73 of the cover body 70. In this variation, an oil seal 101, which serves as the sealing member 100, is disposed inside the circular cylindrical portion 73 to close the gap between the rotary shaft 11 and the cover body 70 which perform rotational movements.

Also, a recess groove 78 for housing an O-ring 102 serving as the sealing member 100 is provided in the surface, which faces the circular cylindrical portion 60, of the cover body 70.

Also, a recess groove 601 for housing an O-ring 103 serving as the sealing member 100 is provided in the surface, close to the cover body 70, of the circular cylindrical portion 60. The recess groove 601 is formed at a position that faces a bearing 120 disposed inside the cover body 70. Also, a recess groove 602 for housing an O-ring 104 serving as the sealing member 100 is provided in the surface, which faces the shaft supporting member 49, of the circular cylindrical portion 60.

Also, a circular cylindrical portion 491 protruding forward is provided in the center of the front surface of the shaft supporting member 49. A shaft body 31 of an output shaft 30 is inserted into a hole of the circular cylindrical portion 491. A step portion 492 for disposing an O-ring 105 serving as the sealing member 100 is provided in an inside surface of the circular cylindrical portion 491.

In the state that the inner cover unit 3 is assembled, the gap between the rotary shaft 11 of the motor 10 and the circular cylindrical portion 73 of the cover body 70 is closed with the oil seal 101. Also, the gap between the cover body 70 and the circular cylindrical portion 60 is closed with the O-rings 102 and 103. In addition, the gap between the circular cylindrical portion 60 and the shaft supporting member 49 is closed with the O-ring 104. Furthermore, the gap between the circular cylindrical portion 491 of the shaft supporting member 49 and the output shaft 30 is closed with the O-ring 105. In this manner, the gaps in the inner cover unit 3 are closed with the sealing members 100, which reduces the chances that the lubricant filled in the inner cover unit 3 leaks out of the inner cover unit 3. This allows for further reducing the chances that a lubricating effect of the lubricant deteriorates. In the inner cover unit 3 shown in FIGS. 8 and 9, the sealing member 100 is constituted by the oil seal 101 and the O-rings 102–105.

Note that the sealing member 100 does not have to be constituted by the oil seal 101 and the O-rings 102–105. Alternatively, the number and types of the seal members serving as the sealing member 100 may be changed as appropriate.

Note that, in the inner cover unit 3 shown in FIGS. 8 and 9, the method for joining the circular cylindrical portion 60 and the cover body 70 is a screw fixing method using the screw 200. However, the method for joining the circular cylindrical portion 60 and the cover body 70 is not limited to the method described above.

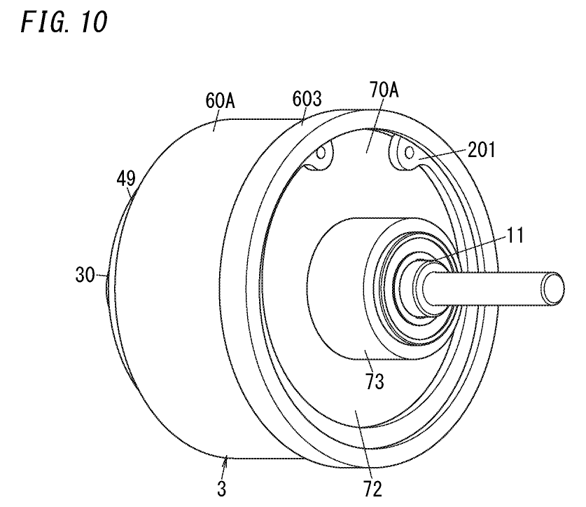

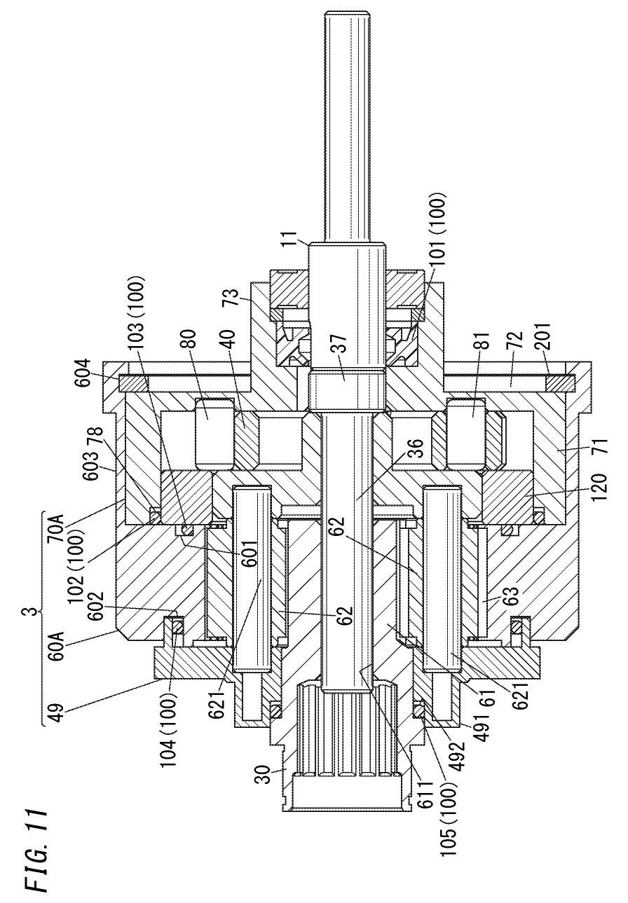

For example, a circular cylindrical portion 60A and a cover body 70A may be joined together by a retaining ring fixing method using a retaining ring 201 as shown in FIGS. 10 and 11. An inner cover unit 3 shown in FIGS. 10 and 11 includes the same configuration as the inner cover unit 3 shown in FIGS. 8 and 9 except that the circular cylindrical portion 60A and the cover body 70A are joined to each other using the retaining ring 201, and therefore, constituent elements having the same feature will be designated by the same reference sign and description thereof will be omitted herein to avoid redundancy.

In the inner cover unit 3 shown in FIGS. 10 and 11, a cover portion 603 having a hollow and circular cylindrical shape and protruding backward from the outer periphery on the back surface of the circular cylindrical portion 60A is provided as an integrated member with the circular cylindrical portion 60A. The cover body 70A is inserted inside the cover portion 603.

A recess groove 604 into which the retaining ring 201 is inserted is provided in the inner surface of the cover portion 603. The recess groove 604 is provided at a position, which is located slightly rearward from the back surface of the cover body 70A inserted inside the cover portion 603.

In this inner cover unit 3, the retaining ring 201 is fitted into the recess groove 604 with the cover body 70A inserted inside the cover portion 603 of the circular cylindrical portion 60A. In this state, the cover body 70A is held between the back surface of the circular cylindrical portion 60A and the retaining ring 201, thus the circular cylindrical portion 60A and the cover body 70A are joined together.

In the state that the inner cover unit 3 is assembled, the gap between the rotary shaft 11 of the motor 10 and the circular cylindrical portion 73 of the cover body 70A is closed with the oil seal 101. Also, the gap between the cover body 70A and the circular cylindrical portion 60A is closed with the O-rings 102 and 103. In addition, the gap between the circular cylindrical portion 60A and the shaft supporting member 49 is closed with the O-ring 104. Furthermore, the gap between the circular cylindrical portion 491 of the shaft supporting member 49 and the output shaft 30 is closed with the O-ring 105. In this manner, the gaps in the inner cover unit 3 are closed with the sealing members 100, which reduces the chances that the lubricant filled in the inner cover unit 3 leaks out of the inner cover unit 3. This allows for further reducing the chances that a lubricating effect of the lubricant deteriorates. In the inner cover unit 3 shown in FIGS. 10 and 11, the sealing member 100 is constituted by the oil seal 101 and the O-rings 102–105.

Note that the sealing member 100 does not have to be constituted by the oil seal 101 and the O-rings 102–105. Alternatively, the number and types of the seal members serving as the sealing member 100 may be changed as appropriate.

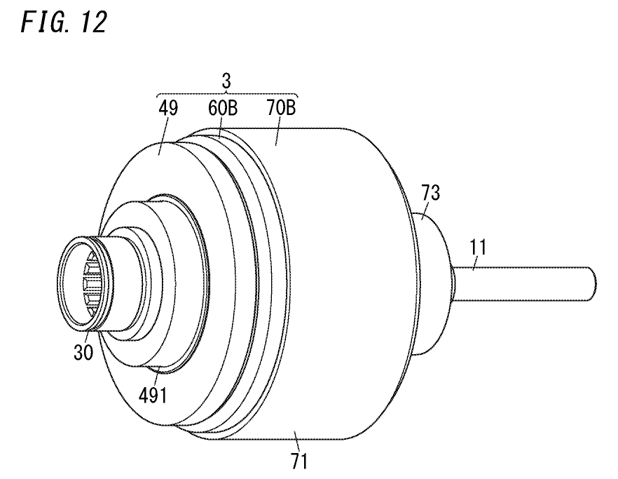

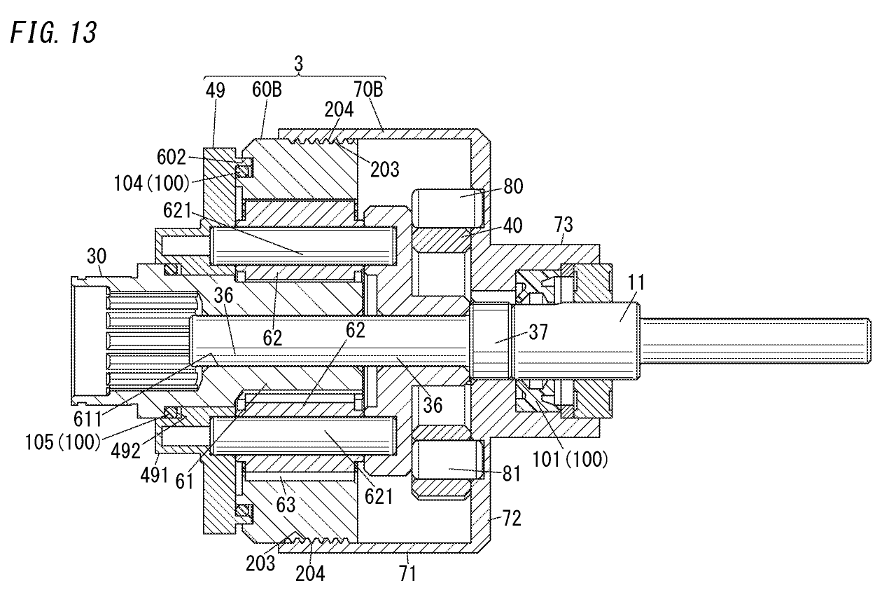

Also, as shown in FIGS. 12 and 13, a circular cylindrical portion 60B and a cover body 70B may also be joined by another fixing method, namely a threaded case fixing method. As used herein, the threaded case fixing method indicates a method for joining the circular cylindrical portion 60B and the cover body 70B by screwing an external thread portion provided for one of the circular cylindrical portion 60B and the cover body 70B into an internal thread portion provided for the other one of the circular cylindrical portion 60B and the cover body 70B. Note that the inner cover unit 3 shown in FIGS. 12 and 13 includes the same configuration as the inner cover unit 3 shown in FIGS. 8 and 9 except that the circular cylindrical portion 60B and the cover body 70B are joined to each other by the threaded case fixing method. Therefore, constituent elements having the same feature will be designated by the same reference sign and description thereof will be omitted herein to avoid redundancy.

The cylindrical portion 71 of the cover body 70B protrudes forward to have an area overlapping with the outer peripheral surface of the circular cylindrical portion 60B. Also, an internal thread 204 is provided for the area, which overlaps with the outer peripheral surface of the circular cylindrical portion 60B, on the inner peripheral surface of the cylindrical portion 71 of the cover body 70B. In the same manner, an external thread 203, which is to engage with the internal thread 204, is provided for the outer peripheral surface of the circular cylindrical portion 60B.

An assembling worker inserts the circular cylindrical portion 60B into the cylindrical portion 71 of the cover body 70B, and then turns the cover body 70B relative to the circular cylindrical portion 60B. As a result, the external thread 203 is screwed into the internal thread 204, thus the circular cylindrical portion 60B and the cover body 70B are joined together to form the inner cover unit 3.

In the state that the inner cover unit 3 is assembled, the internal thread 204 of the cover body 70B and the external thread 203 of the circular cylindrical portion 60B engage with each other, thus the gap between the cylindrical portion 71 of the cover body 70B and the outer peripheral surface of the circular cylindrical portion 60B is closed. Also, the gap between the rotary shaft 11 of the motor 10 and the circular cylindrical portion 73 of the cover body 70B is closed with the oil seal 101. In addition, the gap between the circular cylindrical portion 60B and the shaft supporting member 49 is closed with the O-ring 104. Furthermore, the gap between the circular cylindrical portion 491 of the shaft supporting member 49 and the output shaft 30 is closed with the O-ring 105. In this manner, the gaps in the inner cover unit 3 are closed with the sealing members 100, which reduces the chances that the lubricant filled in the inner cover unit 3 leaks out of the inner cover unit 3. This allows for further reducing the chances that a lubricating effect of the lubricant deteriorates. In the inner cover unit 3 shown in FIGS. 12 and 13, the sealing member 100 is constituted by the oil seal 101 and the O-rings 104 and 105.

Note that the sealing member 100 does not have to be constituted by the oil seal 101 and the O-rings 104 and 105. Alternatively, the number and types of the seal members serving as the sealing member 100 may be changed as appropriate.

Note that the configuration of the second variation may be applied to the impact rotary tool 1 according to the first variation. Sealing the inner cover unit 3A with the sealing member 100 reduces the chances that the lubricant filled in the inner cover unit 3A leaks out.

### (3.3) Third Variation

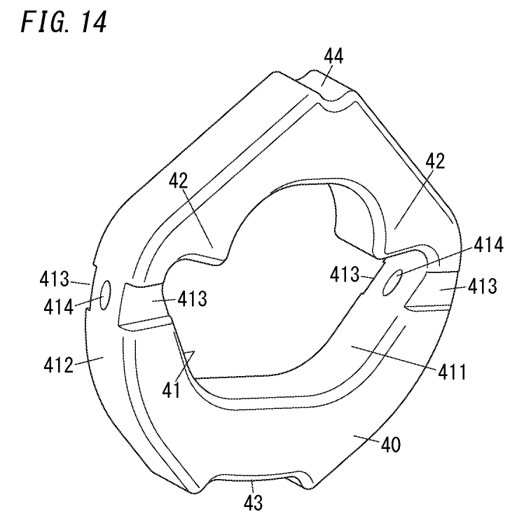

A hammer member 40 included in an impact rotary tool 1 according to a third variation will be described with reference to FIG. 14. In the impact rotary tool 1 according to the third variation, the hammer member 40 is provided with a communicating portion for connecting an inner surface 411 and outer surface 412 of the hammer member 40, which is a difference from the impact rotary tool 1 according to the basic configuration. In the third variation, the inner surface 411 of the hammer member 40 refers to the wall surface of an insertion hole 41 provided for the hammer member 40, and the outer surface 412 of the hammer member 40 refers to the side surface of the hammer member 40 having the shape of a hollow cylinder. Note that the impact rotary tool 1 according to the third variation includes the same configuration as the basic configuration except for the communicating portion provided for the hammer member 40, and therefore, constituent elements of the impact rotary tool 1 according to the third variation having the same feature as the basic configuration will be designated by the same reference sign and description thereof will be omitted herein to avoid redundancy.

In the impact rotary tool 1 according to the basic configuration, as described in “(2.3) Description of operations,” once the inner cover unit 3 has started rotating in response to the rotation of the rotary shaft 11 of the motor 10, the hit portion 48 provided for the cylindrical portion 47 is hit by the hitting portion 42 of the hammer member 40 housed in the inner cover unit 3. When the hitting portion 42 of the hammer member 40 hits the hit portion 48, the hammer member 40 swings around the cam pin 80 (serving as the second cam pin), thus the hitting portion 42 climbs over the hit portion 48. In that step, suppose that a lubricant is filled inside the inner cover unit 3, the lubricant provided between the inner surface of the inner cover unit 3 and the hammer member 40 could act, depending on viscosity or consistency of the lubricant, as resistance with respect to the swings of the hammer member 40 when the hammer member 40 is about to swing around the cam pin 80. This could inhibit swings of the hammer member 40. If the swings of the hammer member 40 around the cam pin 80 are inhibited, then the hitting portion 42 of the hammer member 40 is no longer able to climb over the hit portion 48. This possibly causes a situation where the impact mechanism 4 including the hammer member 40 is locked.

Therefore, in the hammer member 40 included in the impact rotary tool 1 according to the third variation, the communicating portion for connecting the inner surface 411 and outer surface 412 of the hammer member 40 is provided in a direction intersecting with a direction aligned with the axis of the output shaft 30. The lubricant may move(pass) through this communicating portion. In that case, the communicating portion provided for the hammer member 40 may include a recess groove 413 provided in the surface of the hammer member 40 and/or a penetration hole 414 penetrating through the hammer member 40.

For example, the hammer member 40 shown in FIG. 14 has the shape of a hollow cylinder and is provided with an insertion hole 41 aligned with the axial direction of the output shaft 30. As the communicating portion, two recess grooves 413 and a penetration hole 414 are provided for each of two portions arranged to align with a direction which intersecting with a direction defined by connecting the first groove 43 and the second groove 44.

The two recess grooves 413 are respectively provided in surfaces on the both sides of the hammer member 40 with respect to the axial direction of the output shaft 30. Each of the two recess grooves 413 extends along a direction intersecting with the axial direction of the output shaft 30 and intersecting with a direction defined by connecting the first groove 43 and the second groove 44. Each of the two recess grooves 413 is provided for the hammer member 40 having the shape of a hollow cylinder to extend from the inner surface 411 to the outer surface 412.

Also, the penetration hole 414 is provided to penetrate through the hammer member 40 along a direction intersecting with the axial direction of the output shaft 30 and intersecting with a direction defined by connecting the first groove 43 and the second groove 44. One end of the penetration hole 414 opens to the inner surface 411 and the other end of the penetration hole 414 opens to the outer surface 412.

In the impact rotary tool 1 according to the third variation, if the hammer member 40 swings around the cam pin 80 when the hitting portion 42 of the hammer member 40 hits the hit portion 48 in response to the rotation of the inner cover unit 3, the lubricant provided between the inner surface of the inner cover unit 3 and the hammer member 40 may flow (pass) through the two recess grooves 413 and the two penetration holes 414. This reduces the chances that the lubricant, which is provided between the inner surface of the inner cover unit 3 and the hammer member 40, acts as a wall (as resistance), thus allowing for avoiding a situation where the hammer member 40 less easily swings around the cam pin 80. This reduces the chances that the impact mechanism 4 is locked.

The hammer member 40 shown in FIG. 14 is provided with the two recess grooves 413 and the penetration hole 414. However, the hammer member 40 does not have to be provided with all of the two recess grooves 413 and the penetration hole 414. Alternatively, the number and the shape of communicating portions provided for the hammer member 40 may be changed as appropriate.

Also, the communicating portion (e.g., the recess groove 413 and the penetration hole 414) described in the third variation may be provided for the hammer member 40 included in the impact rotary tool 1 according to the first variation or the second variation, which allows for reducing the chances that the impact mechanism 4 is locked.

### (3.4) Fourth Variation

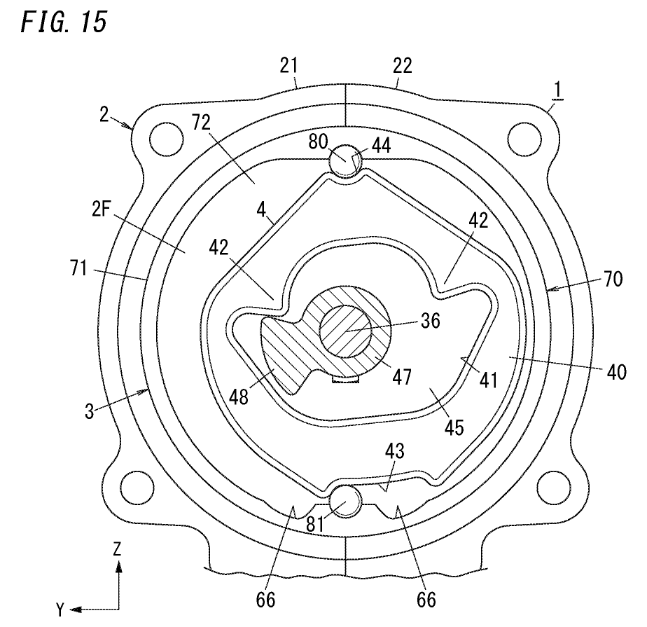

An impact rotary tool 1 according to a fourth variation will be described with reference to FIG. 15. In the impact rotary tool 1 according to the fourth variation, a recess portion 66 is provided for the inner cover unit 3 in an area that faces a first groove 43 in a direction intersecting with the axial direction of the output shaft 30, which is a difference from the impact rotary tool 1 according to the basic configuration. Note that the impact rotary tool 1 according to the fourth variation includes the same configuration as the basic configuration except for the recess portion 66 provided in the inner surface of the inner cover unit 3, and therefore, constituent elements of the impact rotary tool 1 according to the fourth variation having the same feature as the basic configuration will be designated by the same reference sign and description thereof will be omitted herein to avoid redundancy.

In the impact rotary tool 1 according to the fourth variation, the recess portion 66 is provided in the inner surface of the inner cover unit 3 at a position in the vicinity of a cam pin 81 (serving as the first cam pin) inserted into the first groove 43 of a hammer member 40.

In the impact rotary tool 1 according to the fourth variation, if the hammer member 40 swings around the cam pin 80 when a hitting portion 42 of the hammer member 40 hits a hit portion 48 in response to the rotation of the inner cover unit 3, a lubricant provided between the inner surface of the inner cover unit 3 and the hammer member 40 may flow in the recess portion 66 located in the vicinity of the cam pin 81. This reduces the chances that the lubricant, which is provided between the inner surface of the inner cover unit 3 and the hammer member 40, acts as a wall (as resistance), thus allowing for avoiding a situation where the hammer member 40 less easily swings around the cam pin 80. This reduces the chances that the impact mechanism 4 is locked.

Note that the configuration of the fourth variation may be applied to the impact rotary tool 1 according to any of the first to third variations, which allows for reducing the chances that the impact mechanism 4 is locked.

### (3.5) Other variations

An impact rotary tool 1 may also include an outer shell (not shown) further covering the outside of a body case 2.

The inner cover unit 3 is constituted by three members (namely, the circular cylindrical portion 60, the cover body 70, and the shaft supporting member 49). However, this should not be construed as limiting. Alternatively, the inner cover unit 3 may also be constituted by two members or equal to or more than four members. The same statement applies to the inner cover unit 3A constituted by two members (namely, the first cylindrical body 90 and the second cylindrical body 95). The inner cover unit 3A may also be constituted by equal to or more than three members.

### (Recapitulation)

The exemplary embodiment and its variations described above are specific implementations of the following aspects of the present disclosure.

An impact rotary tool (1) according to a first aspect includes a motor (10), an output shaft (30), a hit portion (48, 48A, 48B), a speed reducing mechanism (6), and an impact mechanism (4). The motor (10) is configured to cause a rotary shaft (11) to rotate. A tip tool (T1) is attachable to the output shaft (30). The hit portion (48, 48A, 48B) is configured to rotate together with the output shaft (30). The speed reducing mechanism (6) is configured to decelerate rotation of the rotary shaft (11) and transmits rotation that has been decelerated to the output shaft (30). The impact mechanism (4) includes a hammer member (40, 40A, 40B) that rotates in response to the rotation of the rotary shaft (11) and hits the hit portion (48, 48A, 48B). The impact mechanism (4) is disposed between the speed reducing mechanism (6) and the motor (10).

According to this aspect, the speed reducing mechanism (6) decelerates the rotation of the rotary shaft (11) of the motor (10) and transmits the decelerated rotation to the output shaft (30), thereby the hit portion (48) rotates at the speed thus reduced by the speed reducing mechanism (6). In addition, the hammer member (40) rotates in response to the rotation of the rotary shaft (11) to hit the hit portion (48), thus causing the output shaft (30) to rotate. In this case, the hit portion (48) rotates at the speed reduced by the speed reducing mechanism (6), which reduces the impulse applied to the hit portion (48) compared with a situation where the hit portion (48) that stays still is hit by the hammer member (40). This allows for providing the impact rotary tool (1) which can reduce the hitting sound.

In an impact rotary tool (1) according to a second aspect, which may be implemented in conjunction with the first aspect, the impact mechanism (4) and the speed reducing mechanism (6) are arranged to be adjacent to each other.

This aspect contributes to reducing the size of the impact rotary tool (1) compared with a situation where another member is interposed between the impact mechanism (4) and the speed reducing mechanism (6).

An impact rotary tool (1) according to a third aspect, which may be implemented in conjunction with the first or second aspect, further includes a body case (2) and an inner cover unit (3, 3A). The body case (2) houses the motor (10), the output shaft (30), the hit portion (48, 48A, 48B), the speed reducing mechanism (6), and the impact mechanism (4). The inner cover unit (3, 3A) is housed in the body case (2) and covers the speed reducing mechanism (6) and the impact mechanism (4).

According to this aspect, since the inner cover unit (3, 3A) housed in the body case (2) covers the impact mechanism (4) and the speed reducing mechanism (6), the speed reducing mechanism (6) and the impact mechanism (4) are double-covered by the inner cover unit (3, 3A) and the body case (2). This allows for reducing the hitting sound transmitted to the outside of the body case (2) if a hitting sound is generated when the hammer members (40, 40A, 40B) hit the hit portions (48, 48A, 48B).

In an impact rotary tool (1) according to a fourth aspect, which may be implemented in conjunction with the third aspect, the inner cover unit (3) rotates in response to the rotation of the rotary shaft (11).

According to this aspect, energy generated by the impact can be converted into inertial energy by the rotation of the inner cover unit (3), which allows for increasing the output torque.

In an impact rotary tool (1) according to a fifth aspect, which may be implemented in conjunction with the third aspect, the inner cover unit (3A) is fixed to the body case (2).

This aspect can reduce the load applied to the motor (10) compared with a situation where the inner cover unit (3A) rotates in response to the rotation of the rotary shaft (11) of the motor (10).

In an impact rotary tool (1) according to a sixth aspect, which may be implemented in conjunction with any one of the third to fifth aspects, the inner cover unit (3, 3A) is constituted by multiple members assembled together.

This aspect allows for making it easier to perform the operations to put the speed reducing mechanism (6) and the impact mechanism (4) inside the inner cover unit (3, 3A).

An impact rotary tool (1) according to a seventh aspect, which may be implemented in conjunction with any one of the third to sixth aspects, further includes a lubricant filled inside the inner cover unit (3, 3A).

According to this aspect, the inner cover unit (3, 3A) covering the speed reducing mechanism (6) and the impact mechanism (4) allows for reducing the chances that the lubricant filled in the speed reducing mechanism (6) and the impact mechanism (4) splashes, which makes it less easy for a lubricating effect of the lubricant to deteriorate. This reduces the chances that the members belonging to the speed reducing mechanism (6) and the impact mechanism (4) deteriorate.

An impact rotary tool (1) according to an eighth aspect, which may be implemented in conjunction with the seventh aspect, further includes a sealing member (100) for sealing the inner cover unit (3, 3A).

This aspect further reduces the chances that the lubricant filled in the inner cover unit (3, 3A) leaks out of the inner cover unit (3, 3A). This allows for further reducing the chances that the lubricating effect of the lubricant deteriorates.

In an impact rotary tool (1) according to a ninth aspect, which may be implemented in conjunction with the seventh or eighth aspect, the hammer member (40, 40A, 40B) has a shape of a hollow cylinder and is provided with an insertion hole (41) into which the hit portion (48, 48A, 48B) is inserted. The hammer member (40, 40A, 40B) is provided with a communicating portion (413, 414) for connecting an inner surface (411) and outer surface (412) of the hammer member (40, 40A, 40B).

According to this aspect, the lubricant provided between the inside of the inner cover unit (3, 3A) and the hammer member (40, 40A, 40B) may pass through the communicating portion (413, 414) when the hammer member (40, 40A, 40B) hits the hit portion (48, 48A, 48B). Therefore, this aspect achieves the advantage of reducing the chances that the lubricant provided between the inside of the inner cover unit (3, 3A) and the hammer member (40, 40A, 40B) inhibits movements of the hammer member (40, 40A, 40B).

In an impact rotary tool (1) according to a tenth aspect, which may be implemented in conjunction with any one of the seventh to ninth aspects, a first groove (43) and a second groove (44), into which a first cam pin (81, 80) and a second cam pin (80, 81) fixed to the inner cover unit (3, 3A) are respectively inserted, are provided for the hammer member (40, 40A, 40B). The first groove (43) is formed to have a width larger than a diameter of the first cam pin (81, 80). The hammer member (40, 40A, 40B) is allowed to swing around the second cam pin (80, 81) inserted into the second groove (44) within a range that the first cam pin (81) is allowed to move within the first groove (43). A recess portion (66) is provided for the inner surface of the inner cover unit (3, 3A) in an area that faces the first groove (43) in a direction intersecting with an axial direction of the output shaft (30).

According to this aspect, the lubricant provided between the inside of the inner cover unit (3, 3A) and the hammer member (40, 40A, 40B) may flow through the recess portion (66) when the hammer member (40, 40A, 40B) hits the hit portion (48, 48A, 48B). Therefore, this aspect achieves the advantage of reducing the chances that the lubricant provided between the inside of the inner cover unit (3, 3A) and the hammer member (40, 40A, 40B) acts as resistance and inhibits movements of the hammer member (40, 40A, 40B).

In an impact rotary tool (1) according to an eleventh aspect, which may be implemented in conjunction with any one of the first to tenth aspects, a pair of the hit portions (48A, 48B) are respectively provided in positions symmetrical with respect to a rotational axis of the output shaft (30). The impact mechanism (4) includes a pair of the hammer members (40A, 40B) correspond one to one to the pair of the hit portions (48A, 48B). Each of the pair of the hammer members (40A, 40B) hits, in response to rotation of the motor (10), a corresponding one of the pair of the hit portions (48A, 48B).

This aspect allows for applying impacting force equally to the two hit portions (48A, 48B) by the two hammer members (40A, 40B) that hit the two hit portions (48A, 48B) provided respectively in positions symmetrical with respect to the rotational axis of the output shaft (30). In this manner, the two hammer members (40A, 40B) hit the two hit portions (48A, 48B) of the output shaft (30), which enables the output shaft (30) to rotate smoothly.

Note that the features according to the second to eleventh aspects are not essential for the impact rotary tool (1) but may be omitted as appropriate.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An impact rotary tool comprising:
a motor configured to cause a rotary shaft to rotate;
an output shaft to which a tip tool is attachable;
a hit portion configured to rotate together with the output shaft;
a speed reducing mechanism configured to decelerate rotation of the rotary shaft and transmit rotation that has been decelerated to the output shaft; and
an impact mechanism including a hammer member that rotates in response to the rotation of the rotary shaft and hits the hit portion, and
the impact mechanism being disposed between the speed reducing mechanism and the motor.

2. The impact rotary tool of claim 1, wherein
the impact mechanism and the speed reducing mechanism are arranged to be adjacent to each other.

3. The impact rotary tool of claim 1, further comprising:
a body case housing the motor, the output shaft, the hit portion, the speed reducing mechanism, and the impact mechanism; and
an inner cover unit housed in the body case and covering the speed reducing mechanism and the impact mechanism.

4. The impact rotary tool of claim 3, wherein
the inner cover unit rotates in response to the rotation of the rotary shaft.

5. The impact rotary tool of claim 3, wherein
the inner cover unit is fixed to the body case.

6. The impact rotary tool of claim 3, wherein
the inner cover unit is constituted by multiple members assembled together.

7. The impact rotary tool of claim 3, further comprising a lubricant filled inside the inner cover unit.

8. The impact rotary tool of claim 7, further comprising a sealing member for sealing the inner cover unit.

9. The impact rotary tool of claim 7, wherein
the hammer member has a shape of a hollow cylinder and is provided with an insertion hole into which the hit portion is inserted, and
the hammer member is provided with a communicating portion for connecting an inner surface and outer surface of the hammer member.

10. The impact rotary tool of claim 7, wherein
a first groove and a second groove, into which a first cam pin and a second cam pin fixed to the inner cover unit are respectively inserted, are provided for the hammer member,
the first groove is formed to have a width larger than a diameter of the first cam pin,
the hammer member is allowed to swing around the second cam pin inserted into the second groove within a range that the first cam pin is allowed to move within the first groove, and
a recess portion is provided for the inner cover unit in an area that faces the first groove in a direction intersecting with an axial direction of the output shaft.

11. The impact rotary tool of claim 1, wherein
a pair of the hit portions are respectively provided in positions symmetrical with respect to a rotational axis of the output shaft,
the impact mechanism includes a pair of the hammer members correspond one to one to the pair of the hit portions, and
each of the pair of the hammer members hits, in response to rotation of the motor, a corresponding one of the pair of the hit portions.

12. The impact rotary tool of claim 2, further comprising:
a body case housing the motor, the output shaft, the hit portion, the speed reducing mechanism, and the impact mechanism; and
an inner cover unit housed in the body case and covering the speed reducing mechanism and the impact mechanism.

13. The impact rotary tool of claim 4, wherein
the inner cover unit is constituted by multiple members assembled together.

14. The impact rotary tool of claim 5, wherein
the inner cover unit is constituted by multiple members assembled together.

15. The impact rotary tool of claim 4, further comprising a lubricant filled inside the inner cover unit.

16. The impact rotary tool of claim 5, further comprising a lubricant filled inside the inner cover unit.

17. The impact rotary tool of claim 6, further comprising a lubricant filled inside the inner cover unit.

18. The impact rotary tool of claim 8, wherein
the hammer member has a shape of a hollow cylinder and is provided with an insertion hole into which the hit portion is inserted, and
the hammer member is provided with a communicating portion for connecting an inner surface and outer surface of the hammer member.

19. The impact rotary tool of claim 8, wherein
a first groove and a second groove, into which a first cam pin and a second cam pin fixed to the inner cover unit are respectively inserted, are provided for the hammer member,
the first groove is formed to have a width larger than a diameter of the first cam pin,
the hammer member is allowed to swing around the second cam pin inserted into the second groove within a range that the first cam pin is allowed to move within the first groove, and
a recess portion is provided for the inner cover unit in an area that faces the first groove in a direction intersecting with an axial direction of the output shaft.

20. The impact rotary tool of claim 9, wherein
a first groove and a second groove, into which a first cam pin and a second cam pin fixed to the inner cover unit are respectively inserted, are provided for the hammer member,
the first groove is formed to have a width larger than a diameter of the first cam pin,
the hammer member is allowed to swing around the second cam pin inserted into the second groove within a range that the first cam pin is allowed to move within the first groove, and
a recess portion is provided for the inner cover unit in an area that faces the first groove in a direction intersecting with an axial direction of the output shaft.
